(19) United States
(12) Patent Application Publication
(10) Pub. No.: US 2026/0229555 A1
(43) Pub. Date: Aug. 6, 2026

(54) BONDING LAYER FOR AN ELECTRODE IN SOLID OXIDE FUEL CELLS AND METHOD OF MANUFACTURE THEREOF

(71) Applicant: UNIVERSITY OF CONNECTICUT, Farmington, CT (US)

(72) Inventors: Xiao-Dong Zhou, Columbia, CT (US); Yudong Wang, Storrs, CT (US); Nengneng Xu, Storrs, CT (US); Zizhou He, Storrs, CT (US); Christabel Adjah-Tetteh, Knoxville, TN (US)

(21) Appl. No.: 19/468,709

(22) Filed: Feb. 3, 2026

Related U.S. Application Data
(60) Provisional application No. 63/753,300, filed on Feb. 3, 2025.

(51) Int. Cl. H01M 8/0236; H01M 8/12

(52) U.S. Cl. CPC H01M 8/0236; H01M 8/12; H01M 2008/1293

(57) ABSTRACT

A bonding layer disposed on a substrate is disclosed. The bonding layer includes a single-phase spinel-type metal oxide having a nominal composition MnₓCo₃₋_{ₓ}O₄, where x ranges from 0 to 3, excluding x=2. The bonding layer is formed by sintering a reduced calcined intermediate, during which the reduced calcined intermediate is reoxidized to form the single-phase spinel-type metal oxide. The reduced calcined intermediate is derived from a calcined intermediate produced by calcining an oxide intermediate precursor formed via a combustion reaction between an organic fuel and a precursor comprising one or more metal nitrates. The metal nitrates include manganese nitrate, cobalt nitrate, iron nitrate, copper nitrate, nickel nitrate, zinc nitrate, or combinations thereof. Also disclosed herein is a method of forming the bonding layer.

### CROSS REFERENCE TO RELATED APPLICATIONS

This application claims priority to U.S. Provisional Application No. 63/753,300, filed on Feb. 3, 2025, and the entire contents of which are incorporated herein by reference for all purposes.

### STATEMENT REGARDING FEDERALLY SPONSORED RESEARCH

This invention was made with government support under DE-AR0001774 awarded by the U.S. Department of Energy. The government has certain rights in the invention.

### BACKGROUND OF THE INVENTION

### 1. Field of the Invention

The invention disclosed herein relates to fuel cells, and in particular to bonding layers between interconnects in solid oxide cells. In particular, this disclosure relates to a bonding layer for a solid oxide fuel cell and to methods of manufacture for the solid oxide fuel cell.

### 2. Description of the Related Art

A fuel cell is an electrochemical device that converts the chemical energy of a fuel (for example, hydrogen) and an oxidant (for example, oxygen) directly into electricity, heat, and water. Unlike combustion engines, fuel cells do not rely on burning fuel but instead use redox reactions to generate electricity efficiently and cleanly. The key reaction in a hydrogen fuel cell is:

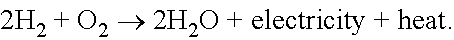

This reaction occurs through the separation of protons and electrons at the anode, with electrons flowing through an external circuit to generate power while protons migrate through an electrolyte to the cathode, where they recombine with oxygen to form water.

There are several types of fuel cells, each differing in electrolyte composition, operating temperature, and applications: proton exchange membrane fuel cells (PEMFCs) generally operate at low temperatures (60 to 100° C.), use polymer electrolyte membranes, and are suitable for automobiles and portable power sources; solid oxide fuel cells (SOFCs) generally operate at high temperatures (600 to 1000° C.), use ceramic electrolytes, and are suitable for stationary power generation and industrial applications; molten carbonate fuel cells (MCFCs) generally operate at high temperatures (~650° C.), use molten carbonate salts as electrolytes, and are common in large-scale power plants; alkaline fuel cells (AFCs) generally use alkaline electrolytes (KOH or NaOH), and have been used in space missions; and phosphoric acid fuel cells (PAFCs) generally operate at 200° C. and are suitable for medium-scale power generation.

A solid oxide fuel cell system comprises four major components: an anode for fuel oxidation, a cathode for reduction of oxygen, an electrolyte for oxide ion transport and interconnectors for electricity conduction, reactant distribution and separation. Components include an anode (which may be referred to as a “fuel electrode”) which may include nickel-yttria-stabilized zirconia (Ni—YSZ). The anode facilitates oxidation of fuel and electron release. Another component is a cathode (which may be referred to as an “oxygen electrode”). The cathode may include lanthanum strontium manganite (LSM) and reduces oxygen from the air, forming oxide ions. A third component is the electrolyte. Generally, the electrolyte may be provided as a solid ceramic material such as yttria-stabilized zirconia (YSZ) and enables conduction of oxide ions (O²⁻) from the cathode to the anode. In SOFC stacks, the interconnects serve as conductive bridges between individual fuel cells, enabling current flow while preventing gas leakage.

One of the challenges that SOFC developers face is the loss in the cell power due to high contact resistance between interconnectors and electrodes. Thus, bonding layers, meshes and pastes are often applied between interconnectors and anode/cathode electrodes in order to assist with better current collection by reducing the electrode/interconnector interfacial resistance.

Despite their importance, current bonding layers face challenges. For example, thermal expansion mismatch may cause different materials in the SOFC stack to expand at different rates, leading to delamination or cracking of the bonding layer. In addition, chemical instability such as that arising at high operating temperatures (~800 to 1000° C.) can lead to oxidation, phase degradation, and reactions with interconnect materials. Increasing electrical resistance over time due to oxide formation and aging lead to higher resistivity, reducing overall fuel cell efficiency. Further, mechanical stress issues may arise from cyclic heating and cooling leading to fatigue failures, reducing the durability of the SOFC stack.

Accordingly, there remains an unmet need for improved bonding layers for solid oxide fuel cell stack assemblies that can provide reliable mechanical attachment and low electrical contact resistance under high-temperature operating conditions. In particular, there is a need for bonding layers that exhibit enhanced thermal and chemical stability, compatibility with interconnects and electrode materials, and resistance to degradation during prolonged operation and repeated thermal cycling.

### SUMMARY OF THE INVENTION

In one aspect, disclosed herein is a bonding layer disposed on a substrate. The bonding layer comprises a single-phase spinel-type metal oxide having a nominal composition of MnₓCo₃₋_{ₓ}O₄, where x ranges from 0 to 3, excluding x=2. The bonding layer is formed by sintering a reduced calcined intermediate such that the reduced calcined intermediate is reoxidized during the sintering to form the single-phase spinel-type metal oxide. The reduced calcined intermediate derives from a calcined intermediate produced by calcining an oxide intermediate precursor formed by a combustion reaction between an organic fuel and a precursor. The precursor comprises one or more metal nitrates that comprise manganese nitrate, cobalt nitrate, iron nitrate, copper nitrate, nickel nitrate, zinc nitrate, and a combination thereof.

In another aspect, disclosed herein is a method of forming a bonding layer on a substrate. The method comprises forming a first mixture comprising a precursor, an organic fuel, and a first solvent. The precursor comprises one or more metal nitrates that include manganese nitrate, cobalt nitrate, iron nitrate, copper nitrate, nickel nitrate, zinc nitrate, and a combination thereof. The method comprises stirring the first mixture to form a homogeneous first mixture. The method comprises heating the homogeneous first mixture at a first temperature to evaporate the first solvent and form a gel-like first mixture. The method comprises heating the gel-like first mixture at a second temperature to initiate a combustion reaction between the organic fuel and the metal nitrates and thereby form an oxide intermediate precursor. The method comprises calcining the oxide intermediate precursor at a third temperature in an oxidizing atmosphere to form a calcined intermediate that comprises a manganese-cobalt spinel oxide having a nominal composition of MnₓCo₃₋ₓO₄, where x ranges from 0 to 3, excluding x=2. The method comprises exposing the calcined intermediate to a reducing gas mixture at a fourth temperature to at least partially reduce the calcined intermediate and form a reduced calcined intermediate. The method comprises forming a contact paste comprising the reduced calcined intermediate and one or more organic constituents. The method comprises applying the contact paste to a surface of the substrate and sintering the contact paste at a fifth temperature to remove the organic constituents and form the bonding layer on the substrate. The bonding layer comprises a single-phase spinel-type metal oxide formed by reoxidation of the reduced calcined intermediate during the sintering.

In another aspect, disclosed herein is a solid oxide fuel cell that comprises an anode, a cathode, an electrolyte disposed between the anode and the cathode, and an interconnect electrically coupled to at least one of the anode or the cathode. The solid oxide fuel cell comprises a bonding layer disposed on at least one of the anode, the cathode, or the interconnect. The the bonding layer comprises a single-phase spinel-type metal oxide having a nominal composition MnₓCo₃₋_{ₓ}O₄, where x ranges from 0 to 3, excluding x=2. The bonding layer is formed by sintering a reduced calcined intermediate such that the reduced calcined intermediate is reoxidized during the sintering to form the single-phase spinel-type metal oxide. The reduced calcined intermediate is derived from a calcined intermediate produced by calcining an oxide intermediate precursor formed by a combustion reaction between an organic fuel and a precursor. The precursor comprises one or more metal nitrates comprising manganese nitrate, cobalt nitrate, iron nitrate, copper nitrate, nickel nitrate, zinc nitrate, or a combination thereof.

### BRIEF DESCRIPTION OF THE DRAWINGS

The features and advantages of the invention are apparent from the following description taken in conjunction with the accompanying drawings in which:

FIG. 1 is a schematic depiction of an exemplary bonding layer that comprises a single-phase spinel-type metal oxide disposed on a substrate;

FIG. 2 is a schematic depiction of an exemplary reduced calcined intermediate that is disposed on the substrate;

FIG. 3 is a schematic depiction of an exemplary calcined intermediate that is disposed on a substrate;

FIG. 4 is a method of forming a bonding layer on a substrate;

FIG. 5A is a graph that illustrates X-ray diffraction spectra of MnₓCo₃₋ₓO₄ composition after annealing at 400° C. in air for 1 h (C: cubic spinel; T: tetragonal spinel);

FIG. 5B is a graph that illustrates X-ray diffraction spectra of MnₓCo₃₋ₓO₄ composition after reduction in 1:1 H₂+N₂ mixture at 700° C.;

FIG. 5C is a graph that illustrates the effect of composition on the crystallite size and microstrain (for MnₓCo₃₋ₓO₄, x=0-3 annealed at 400° C. in air);

FIG. 5D is a graph that illustrates the effect of composition on reduction and reoxidation onset temperatures;

FIGS. 6A-6C illustrate scanning electron microscope images of a calcined intermediate that comprises a manganese-cobalt spinel oxide having a nominal composition of Mn_{1.5}Co_{1.5}O₄, under the different magnification with scale bars of 5 μm, 2 μm, and 500 nm, respectively;

FIGS. 7A-7C illustrate scanning electron microscope images of a bonding layer that comprises of Mn_{1.5}Co_{1.5}O₄, under the different magnification with scale bars of 5 μm, 2 μm, and 500 nm, respectively;

FIG. 8 is a graph depicting X-ray diffraction patterns of the spinel before reduction;

FIG. 9 is a graph depicting X-ray diffraction patterns of the spinel before and after reduction;

FIG. 10A illustrates an example of a test apparatus used to perform a shear stress test on a bonding layer disposed on a substrate; and

FIG. 10B illustrates a schematic representation of the test configuration with the apparatus as illustrated in FIG. 10A.

### DETAILED DESCRIPTION OF THE INVENTION

Solid oxide fuel cells are formed by stacking a series of planar interconnect layers (often called “plates” or “interconnects”) and the fuel cells to form a fuel cell stack assembly. Most solid oxide fuel cell designs thus include two basic subassemblies, namely the fuel cells and related interconnect plates, stacked on top of one another in alternating fashion. These basic components of the stack must be assembled such that they remain together with good electrical contact at all times in order to reduce ohmic losses. At both the cathode-interconnect interface and the anode-interconnect interface, contact layers, also referred to as bonding layers, are applied between the interconnect and the electrodes during construction of a solid oxide fuel cell stack assembly. The main function of a contact layer is to provide and maintain stable electrical conduction paths between the interconnect and electrodes and thus minimize the interfacial and ohmic resistance and stack power loss. Accordingly, the contact layer is electrically conductive.

Each fuel cell of a solid oxide fuel cell stack assembly can include a cathode, an anode, and an electrolyte disposed between the cathode and the anode. Multiple fuel cells can be connected to one another in succession via an interconnect disposed between adjacent fuel cells. An anode bonding layer can be disposed between the interconnect and the anode, and a cathode bonding layer can be disposed between the cathode and the interconnect. The anode bonding layer and the cathode bonding layer maintain electrical contact between the anode, the interconnect, and the cathode, thereby facilitating the flow of electrical current between adjacent fuel cells.

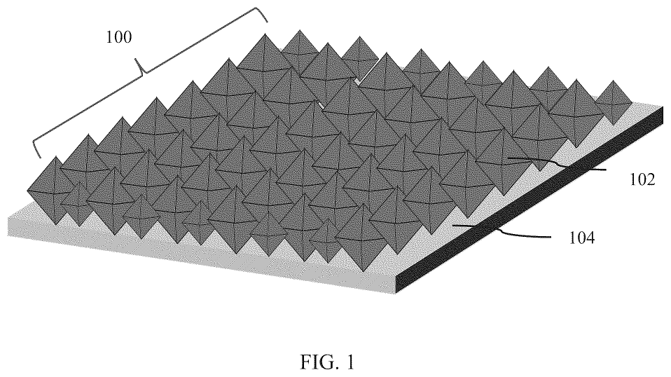

One aspect of the disclosure is a bonding layer that is disposed on a substrate. As shown in FIG. 1, a bonding layer 100 comprises a single-phase spinel-type metal oxide 102 that is disposed on the substrate 104. In some embodiments, the substrate 104 comprises a cathode, an anode, or an interconnect of a fuel cell stack assembly. In some embodiments, the bonding layer 100 is configured to provide mechanical attachment and electrical contact between the substrate 104 and an adjacent component within the fuel cell stack assembly, thereby reducing interfacial contact resistance and improving current collection during operation. The substrate and the adjacent component comprise an anode, a cathode, or an interconnect of a solid oxide fuel cell. In some embodiments, the bonding layer 100 is disposed between an interconnect and a cathode current collector layer, between an interconnect and an anode current collector layer, or between other electrically conductive components of the fuel cell stack assembly. In some embodiments, the bonding layer maintains electrical conductivity and adhesion under high-temperature operating conditions, such as temperatures of about 600° C. to about 900° C., and under repeated thermal cycling encountered during start-up and shutdown of the fuel cell system.

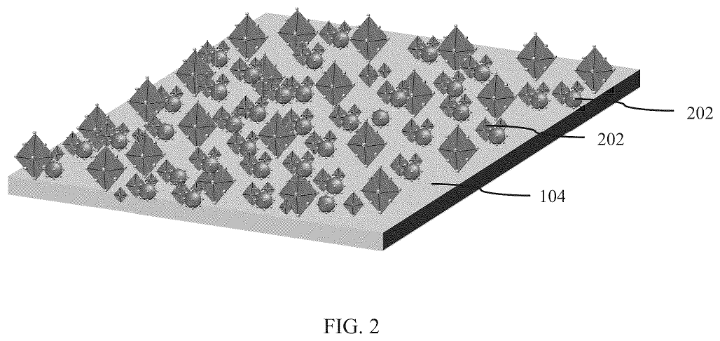

The bonding layer 100 comprises a single-phase spinel-type metal oxide 102 that includes a manganese-cobalt oxide, in which manganese and cobalt together occupy the metal cation sites of the spinel lattice such that the oxide corresponds to a formula MnₓCo₃₋_{ₓ}O₄, where x is a value from 0 to 3, excluding a value of 2. In some embodiments, x is about 0.5 to about 1.99, or about 2.01 to about 2.5. The bonding layer 100 is formed by sintering a reduced calcined intermediate 202 (as shown in FIG. 2) such that the reduced calcined intermediate 202 is reoxidized during the sintering to form the single-phase spinel-type metal oxide 102. In some embodiments, the single-phase spinel-type metal oxide 102 has a cubic, a distorted cubic, or a tetragonal crystal structure. In some embodiments, the single-phase spinel-type metal oxide is substantially free of secondary oxide phases comprising CoO and Mn₂O₃, as determined by X-ray diffraction. As used herein, the term “substantially free of secondary oxide phases” refers to a bonding layer in which the single-phase spinel-type metal oxide constitutes at least about 90% of the bonding layer by volume or by phase fraction, with any remaining portion comprising minor secondary phases or impurities.

In some embodiments, after sintering the reduced calcined intermediate 202 for a period of about 1 hour to about 6 hours, a bonding layer 100 is formed on the surface of the substrate 104. During the sintering process, the reduced calcined intermediate undergoes reoxidation and densification, resulting in the formation of a bonding layer having a substantially single-phase spinel-type crystal structure. In some embodiments, the substantially single-phase spinel structure is confirmed by X-ray diffraction analysis, in which characteristic reflections corresponding to secondary oxide phases are absent or present only at trace levels. In some embodiments, formation of the substantially single-phase spinel structure contributes to improved electrical conductivity, mechanical integrity, and interfacial stability of the bonding layer during operation and thermal cycling.

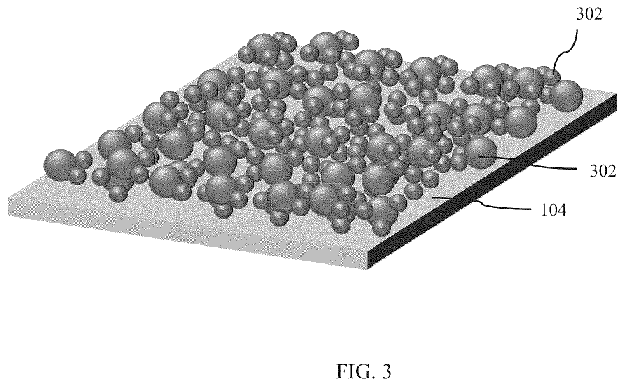

The reduced calcined intermediate 202 derives from a calcined intermediate 302 (as shown in FIG. 3) produced by calcining an oxide intermediate precursor formed by a combustion reaction between an organic fuel and a precursor. In some embodiments, the precursor is a metallic precursor. The precursor may include one or more metals, metal oxides, metal salts, a spinel-type metal oxide, or a combination thereof. In some embodiments, the precursor comprises manganese nitrate, cobalt nitrate, iron nitrate, copper nitrate, nickel nitrate, zinc nitrate, and a combination thereof. In some embodiments, the metal nitrates comprise manganese nitrate Mn(NO₃)₂·xH₂O and cobalt nitrate Co(NO₃)₂·xH₂O, where x is greater than zero. In some embodiments, the metal nitrates comprise cobalt nitrate comprises Co(NO₃)₂·6H₂O, and Mn(NO₃)₂·4H₂O.

In some embodiments, the precursor comprises a powder. In some embodiments, the powder of the precursor has a maximum particle size of up to 20 micrometers, up to 10 micrometers, up to 5 micrometers, up to 4 micrometers, up to 3 micrometers, up to 2 micrometers, or up to 1 micrometer. In some embodiments, the precursor has an average particle diameter of about 0.1 μm to about 20 μm, about 0.5 μm to about 10 μm, or about 1 μm to about 5 μm.

In some embodiments, the bonding layer has a thickness of about 5 to about 100 micrometers, about 10 to about 80 micrometers, about 15 to about 60 micrometers, or about 20 to about 40 micrometers. In some embodiments, the bonding layer exhibits an area-specific resistance (ASR) of less than about 0.1 ohm-centimeters squared (Ω·cm²) at an operating temperature of a solid oxide fuel cell, such as at temperatures of about 600° C. to about 900° C. In some embodiments, the low area-specific resistance is achieved as a result of the single-phase spinel-type metal oxide structure, which provides high electronic conductivity and stable interfacial contact with the substrate. In some embodiments, the bonding layer maintains an area-specific resistance below about 0.08 Ω·cm², below about 0.05 Ω·cm², and below about 0.03 Ω·cm² during prolonged operation and thermal cycling, thereby reducing ohmic losses and improving overall stack efficiency.

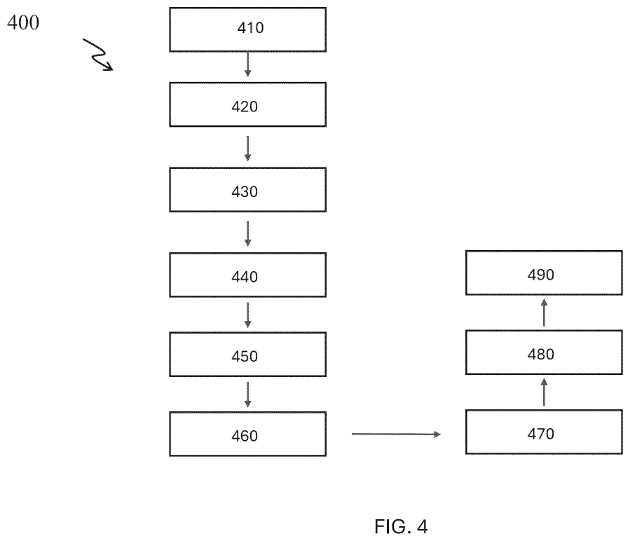

Referring to FIG. 4, one aspect of the disclosure is a method 400 of forming a bonding layer on a substrate. The substrate comprises a cathode, an anode, and an interconnect of a fuel cell stack assembly, which may be a solid oxide fuel cell stack assembly. In some embodiments, the method 400 comprises forming a bonding layer for electrodes and interconnects in solid oxide energy storage devices.

In particular, the method 400 includes preparing a first mixture (referred to as step 410). At step 410, a first mixture that comprises a precursor, an organic fuel, and a first solvent is prepared. As aforementioned, the precursor comprises one or more metal nitrates that comprises manganese nitrate, cobalt nitrate, iron nitrate, copper nitrate, nickel nitrate, zinc nitrate, or a combination thereof. In some embodiments, the metal nitrates comprise manganese nitrate Mn(NO₃)₂·xH₂O and cobalt nitrate Co(NO₃)₂·xH₂O, where x is greater than zero. The organic fuel comprises glycine and the first solvent comprises distilled water, deionized water, or purified water. The first solvent is selected to dissolve or disperse the precursor and the organic fuel. In some embodiments, a molar ratio of the organic fuel to nitrate ions of the metal nitrates is about 1:1. In some embodiments, the molar ratio of the organic fuel to nitrate ions of the metal nitrates is about 0.8:1 to about 1.2:1, about 0.9:1 to about 1.1:1, or about 0.95:1 to about 1.05:1.

The method 400 continues by homogenizing the first mixture (referred to as step 420). At step 420, the first mixture is stirred or otherwise agitated to form a homogeneous first mixture. Homogenization promotes uniform distribution of the metal nitrates and the organic fuel, thereby enabling a controlled combustion reaction in subsequent processing.

The method 400 further comprises forming a gel-like mixture (referred to as step 430). At step 430, the homogeneous first mixture is heated at a first temperature to evaporate the first solvent and form a gel-like first mixture. In some embodiments, this step increases the viscosity of the mixture and concentrates the precursor and the organic fuel. The gel-like first mixture is heated at a second temperature to initiate a combustion reaction between the organic fuel and the metal nitrates (referred to as step 440). The combustion reaction produces an oxide intermediate precursor. In some embodiments, the first temperature is about 130° C. to about 180° C., about 140° C. to about 170° C. or about 150° C. to about 165° C. In some embodiments, the second temperature is about 300° C. to about 400° C., about 320° C. to about 380° C., or about 340° C. to about 360° C.

The method 400 further comprises a step calcining the oxide intermediate precursor to form a spinel-containing intermediate (referred to as step 450). At step 450, the oxide intermediate precursor is calcined at a third temperature in an oxidizing atmosphere to form a calcined intermediate. In some embodiments, the calcined intermediate comprises a manganese-cobalt spinel oxide having a nominal composition of MnₓCo₃₋_{ₓ}O₄, where x ranges from 0 to 3, excluding x=2. The calcination step promotes crystallization and phase formation of the spinel-type metal oxide. In some embodiments, the third temperature is about 400° C. to about 600° C., about 450° C. to about 550° C., or about 480° C. to about 520° C.

The method 400 further comprises a step of reduction of the calcined intermediate (referred to as step 460). At step 460, the calcined intermediate is exposed to a reducing gas mixture at a fourth temperature to reduce or at least partially reduce the calcined intermediate and form a reduced calcined intermediate. In some embodiments, the reducing gas mixture comprises hydrogen and an inert gas. The inert gas comprises argon or nitrogen. The reduction modifies the oxidation state and microstructure of the calcined intermediate. In some embodiments, the fourth temperature is about 700° C. to about 800° C., about 720° C. to about 780° C., or about 740° C. to about 760° C.

The method 400 further comprises a step of forming a contact paste (referred to as step 470). At step 470, a contact paste is formed by combining the reduced calcined intermediate with one or more organic constituents. In some embodiments, the organic constituents include a binder, a second solvent, dispersants, or a combination thereof, selected to provide suitable rheological properties for application. In some embodiments, the binder comprises ethyl cellulose, polyvinyl butyral, acrylic binders, or a combination thereof. The second solvent comprises terpineol, alcohols, glycols, or a combination thereof. In some embodiments, the contact paste is provided in the form of a slurry, in which the reduced calcined intermediate is uniformly dispersed within the organic constituents to form a flowable composition. In some embodiments, the contact paste comprises the reduced calcined intermediate suspended in an ink vehicle, wherein the ink vehicle comprises the binder and the second solvent and is configured to maintain the reduced calcined intermediate in a stable, well-dispersed state prior to application. In some embodiments, the rheological properties of the slurry or ink vehicle are tailored to enable painting, dispensing, or screen printing of the contact paste onto a substrate, while minimizing particle agglomeration, sedimentation, or phase separation during storage and application.

In some embodiments, forming the contact paste comprises grinding and sieving the reduced calcined intermediate to form a powder having a maximum particle size of 5 micrometers. The grinding comprises ball milling, attrition milling, bead milling, planetary milling, vibratory milling, rod milling, jet milling, or a combination thereof. In some embodiments, the bonding agent is an anode bonding agent. In some embodiments, the bonding agent is a cathode bonding agent.

The method 400 further comprises a step of applying the contact paste to a substrate (referred to as step 480). In some embodiments, the substrate comprises a cathode, an anode, or an interconnect of a fuel cell stack assembly, such as a solid oxide fuel cell stack assembly. The contact paste may be applied by painting, dispensing, screen printing, or other suitable deposition techniques. In some embodiments, the contact paste is a cathode contact paste. In some embodiments, the contact paste is an anode contact paste.

The method 400 further comprises a step of sintering the contact paste to form a bonding layer (referred to as step 490), which is also referred to a sintered in-situ process. At step 490, the applied contact paste is sintered at a fifth temperature to remove the organic constituents and form the bonding layer on the substrate. During sintering, the reduced calcined intermediate is reoxidized in situ to form a single-phase spinel-type metal oxide. The sintering step promotes particle necking, densification, and intimate mechanical and electrical contact between the bonding layer and the substrate. In some embodiments, the fifth temperature is less than 900° C. In some embodiments, the fifth temperature is between 65° and 850° C., about 750° C. to about 850° C., or about 800° C. to about 820° C. Sintering the contact paste at the fifth temperature of less than 900° C. can help reduce or prevent oxidation of the substrate. In some embodiments, step 490 is performed in an oxidizing environment, wherein the bonding agent can be thermally converted to a single-phase, electrically conductive spinel layer that comprises a single-phase spinel-type metal oxide. Upon heating or sintering, the bonding agents form a cathode bonding layer or an anode bonding layer that permanently bonds the interconnect and the cathode or the anode, in-situ mechanically and electrically. Therefore, the anode is physically bonded to and electrically connected to the interconnect through the anode bonding layer, while the cathode is physically bonded to and electrically connected to the interconnect through the cathode bonding layer.

In some embodiments, step 490 is performed at a predetermined pressure to facilitate sintering of the contact paste and to promote formation of a more uniform microstructure comprising the single-phase spinel-type metal oxide. Application of pressure during sintering may enhance particle rearrangement, neck growth, and densification of the bonding layer, thereby reducing residual porosity and improving mechanical integrity and electrical contact with the substrate. In some embodiments, the sintering is performed at a pressure of about 10 psi to about 5000 psi, such as about 50 psi to about 3000 psi, about 100 psi to about 1500 psi, or about 200 psi to about 800 psi. In some embodiments, the applied pressure improves interfacial conformity between the bonding layer and the substrate, resulting in reduced interfacial contact resistance and enhanced durability during thermal cycling.

In some embodiments, the anode may comprise nickel, palladium, platinum, nickel-zirconia cermet, platinum-zirconia cermet, palladium-zirconia cermet, nickel-cerium oxide cermet, platinum-cerium oxide cermet, palladium-cerium oxide cermet, ruthenium, ruthenium-zirconia cermet, nickel-yttria-stabilized zirconia, or a combination thereof. In some embodiments, the cathode may comprise a lanthanum-containing perovskite composite oxide, lanthanum manganite or lanthanum cobaltite, lanthanum manganite, or a combination thereof. The cathode may comprise lanthanum cobaltite or lanthanum manganite doped with, for example, strontium, calcium, chromium, cobalt, iron, nickel, or aluminum. The cathode may comprise palladium, platinum, ruthenium, platinum-zirconia cermet, palladium-zirconia cermet, ruthenium-zirconia cermet, platinum-cerium oxide cermet, palladium-cerium oxide cermet, ruthenium-cerium oxide cermet, lanthanum strontium manganite, or a combination thereof.

The disclosed bonding layer for electrode and interconnect in solid oxide energy storage devices, are further illustrated by the following non-limiting examples.

### Example

Embodiments and features of the present technology are further illustrated through the following non-limiting examples:

Disclosed herein is a series of MnₓCo₃₋ₓO₄ (MCO, x=0-3) through in situ thermogravimetric and structural analysis to evaluate how the MCO composition affects structure, phase evolution, and redox transition temperatures. Reduction in MCO proceeds via two steps whereas reoxidation of the reduction products (MnO and Co) commonly occurs in a single step. Manganese is seen to reduce the reoxidation temperatures—the spinel peak was first evident at 300° C. for x=2.4 whereas that of x=0.6 appeared at 400° C. Cobalt- and manganese-rich contents (x=0.6 and 2.4) gave rise to CoO and Mn₂O₃ secondary phases respectively during reoxidation. These secondary phases were first observed when the temperature reached 500° C., however, such phases diminished with increasing temperature, yielding a single phase at 800° C. In contrast, the mid-range composition (x=1.8) yields single spinel phases at relatively lower temperatures. The relationship between composition and morphology of exsolved Co and MnO particles during reduction is disclosed herein, which are of importance to catalytic applications. The method disclosed herein can offer guidelines for designing MCO for catalytic and electrochemical applications.

Varying ratios of manganese and cobalt oxides were prepared via the glycine-nitrate combustion method. Cobalt nitrate, Co(NO₃)₂·6H₂O (Thermo Fisher Scientific), and manganese nitrate, Mn(NO₃)₂·4H₂O (Sigma-Aldrich), were employed as precursors. It is to be noted that the nitrates were used as received without any further standardization; hence, the actual amount of crystallized water may differ from the assumed 6 and 4 moles. Stoichiometric amount of the nitrate precursors was dissolved in deionized water and stirred until no visible solids remained. For an oxide target yield of 7.5 g and a Mn:Co ratio of 4:1, 20.081 g of manganese nitrate Mn(NO₃)₂·4H₂O and 5.821 g of Co(NO₃)₂·6H₂O was weighed. The ratios were adjusted accordingly to prepare all other compositions. Glycine was added to the solution as fuel with a molar ratio of 1:1 versus the nitrate ion. Once homogenized, the solution was placed on a hot plate and heated to 350° C. until it ignited. The resulting combustion reaction produced metal oxide powders. These powders were collected and annealed at temperatures 400° C. and 800° C. for 1 h and are denoted as MnₓCo₃₋ₓO₄ with x is from 0 to 3. The reduction of the powders was conducted in a tube furnace at 700° C. This reaction took place in a 1:1 H₂ to N₂ ratio to study the phase transformation that occurs during reduction.

The phase composition of the samples was analyzed by X-ray diffraction (XRD) using a Bruker AXS D8 advanced diffractometer. The diffraction patterns were obtained by employing a copper source and a 2θ scan rate of 3°/min over a range of 15 degrees to 80 degrees. Quantitative analysis of the diffraction patterns was further performed by Rietveld refinement using the FullProf software.

Next, thermogravimetric analysis (TGA) was performed under both reducing and oxidizing conditions using a Shimadzu TGA equipment. The goal of this analysis was to examine the redox behavior of the powders. For reduction, the samples were exposed to a gas mixture containing 5% H₂ and 95% Ar with a constant flow rate of 20 mL/min. The heating for this reaction started from room temperature and increased to 900° C. at a rate of 5° C./min. Following the cooling of the reduced samples to room temperature, the powders were reoxidized in air. This reoxidation occurred under the same flow rate and heating profile as the reduction reaction.

Lastly, an in situ XRD experiment was performed in air using the reduced powders as starting materials. The objective of this experiment was to study the phase changes that occur during reoxidation. The furnace temperature increased from 30° C. to 800° C. with a constant heating rate of 10° C./min. The XRD patterns were recorded at specified temperature intervals with a scan rate of 3°/min over a 2θ range of 15 degrees to 80 degrees.

The morphology and microstructure of the samples were further characterized by scanning electron microscopy (SEM, FEI Verios 460L) and transmission electron microscopy (TEM, Titan Themis AC-STEM), which is equipped with an energy dispersive X-ray (EDX) detector. EDX and inductively coupled plasma optical emission spectroscopy (ICP-OES, Perkin Elmer Optima 7300DV spectrometer) were used to determine the composition of the MnCo oxides. All compositions are designated according to the target formula.

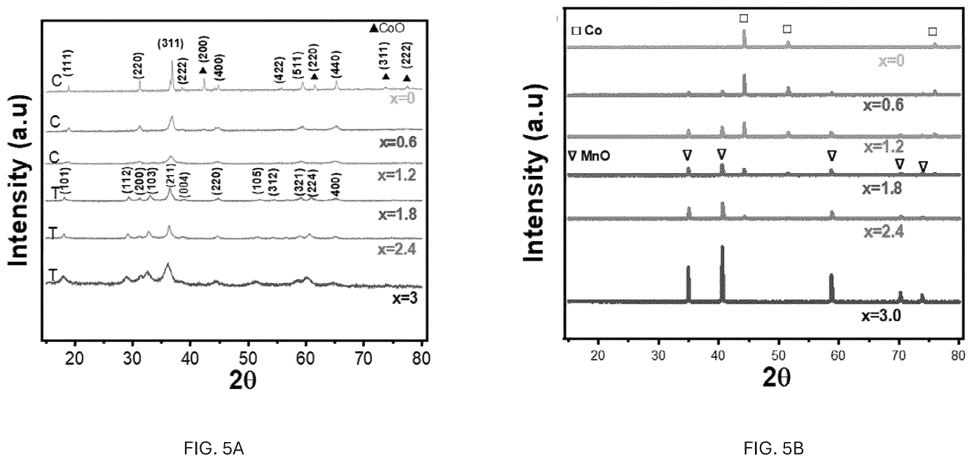

FIG. 5A displays the diffraction patterns of each of the MnₓCo₃₋ₓO₄ compositions. These compositions are the starting materials; synthesized by the glycine nitrate method and annealed at 400° C. to enhance the phase formation and eliminate any residual impurities. A single spinel phase is generally obtained with an exception for high cobalt-containing compositions (MnₓCo₃₋ₓO₄, x=0 and 0.6), which showed secondary CoO phases. However, the secondary CoO phases disappeared when the annealing temperature is increased to 800° C., as identified by the XRD patterns (not shown). These results suggest that the formation of the CoO phases is caused by one of two possibilities: incomplete oxidation or phase segregation during synthesis. Metal oxide spinels with compositions of x values in the range 1.8≤x≤3 crystallized in tetragonal phases, which is an observation for high manganese-containing compositions at room temperature. A tetragonal to cubic phase change is observed for the x=1.2 sample. Further increase in cobalt mole fraction beyond this point leads to structures that also stabilize in the cubic form. This phenomenon indicates that increasing cobalt content stabilizes the cubic phase, which is consistent with observations from previously reported works. According to FIG. 5C, the estimated crystallite size ranges from 4 to 35 nm and the presence of manganese appears to suppress particle size growth in the cubic phase for the mixed oxides. This behavior seemingly contradicts itself as the compositions transition from the cubic phase to the tetragonal phase where the opposite effect is observed. The transition between the two phases causes strong structural distortions and was previously observed to have changed the pattern of the oxygen thermal displacement parameter in the Mn—Co spinel system. This transition is therefore believed to have resulted in a change in the pattern of compositional effect on crystallite size, which is seen after x=1.2. An inverse relationship is observed for the effect of composition on microstrain. Similar results of increasing crystallite size with decreasing manganese content in the cubic-phased region have been previously reported.

Table 1 summarizes the crystal structure information of the various spinel oxide compositions, obtained from Rietveld refinement of the XRD patterns. Abbreviation: DT-cubic, distorted cubic structure.

TABLE 1
Summary of crystal structure information from
Rietveld refinement. Lattice parameter (Å).

| | | a | b | c | Cell |
|---|---|---|---|---|---|
| Composition | Phase | (Å) | (Å) | (Å) | Volume (Å³) |
| Co₃O₄ | Cubic | 8.0671 | 8.0671 | 8.0671 | 524.9846 |
| Mn_{0.6}Co_{2.4}O₄ | DT-cubic | 8.2187 | 8.1192 | 8.1275 | 542.3417 |
| Mn_{1.2}Co_{1.8}O₄ | DT-cubic | 8.2924 | 8.0933 | 8.1549 | 547.2947 |
| Mn_{1.8}Co_{1.2}O₄ | Tetragonal | 5.7231 | 5.7231 | 9.2480 | 302.9116 |
| Mn_{2.4}Co_{0.6}O₄ | Tetragonal | 5.7221 | 5.7221 | 9.2754 | 303.7028 |

Manganese doping causes an expansion in crystal lattice. The reason for this expansion is the effect of substituting Co ions by relatively larger Mn ions (Co²⁺: 0.65 Å [CN=6], Mn²⁺: 0.67 Å [CN=6], Co³⁺: 0.61 Å [CN=6], Mn³⁺: 0.65 Å [CN=6], Mn⁴⁺: 0.53 Å [CN=6]). This relationship is evident by the increase in lattice parameters and lattice volume with increase in manganese content. Although the XRD reflections for compositions x=1.2 and 0.6 match those of a cubic structure in FIG. 5A. Rietveld refinement reveals a rather orthorhombic-like structure for these compositions. However, Mn—Co spinels are not thought to crystallize in an orthorhombic state. Hence, it is believed that these compositions have a distorted cubic structure.

Increasing the annealing temperature from 400° C. to 800° C. revealed a thermally driven transformation of the crystal structure. It transformed from a distorted cubic structure to a full cubic structure with relatively sharp and well-defined peaks. Thus, synthesis conditions play a role in the resulting spinel crystal structure. The XRD patterns shown in FIG. 5B represent the reduced forms of the spinels. These products were obtained by reduction in an H₂ and N₂ mixture at 700° C. for 2 h. The reduction products show a mixture of MnO and face centered cubic (fcc) metallic Co phases. Pure cobalt oxide is reduced into metallic Co and pure manganese oxide is reduced to MnO. The results show that under such reducing conditions, manganese and cobalt exhibit different behavior. Manganese exists as Mn²⁺ and stabilizes as MnO, while cobalt tends to separate into its metallic form. The high-angle annular dark-field-energy dispersive spectrosopy (HAADF-EDS) confirms that cobalt segregates in the metallic form after the reduction process. Furthermore, this imaging illustrates that Co and MnO form block structures that are well interconnected. EDX and ICP-OES were used to analyze the ratios of the as-synthesized MnₓCo₃₋ₓO₄ (not shown). The ratios were observed to be relatively lower than their stoichiometric values, which could indicate the presence of cation vacancies in the spinel or possibly due to the use of the nitrate precursors as received without standardization.

The behavior of the various compositions under reducing conditions was further analyzed. This is to ascertain the effect of composition on reduction temperatures and to also identify intermediate structures that may be formed. The TGA of the oxides during reduction and reoxidation, respectively, shows the weight change of the samples as a function of temperature. The derivative thermogravimetry (DTG) identifies the rate of weight change with temperature. Generally, the compositions undergo two distinctive reduction steps. The first step in the previous report for the mixed compositions is known to have led to the formation of an intermediate compound of the following configuration: (MnₓCo₃₋ₓ)_{1/3}O. Further increasing the temperature under reducing conditions allows for a second reduction step to occur which resultantly yields MnO and Co as shown by the XRD spectra in FIG. 5B. The TGA and DTG profiles of the pure manganese oxide evidently appear to be different from the other compositions. This may be due to the presence of a Mn₂O₃ phase, which is not a spinel. However, upon reduction, the Mn₂O₃ phase transforms into Mn₃O₄ in the first observed reduction step according to Equation (1):

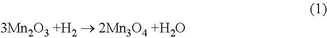

The expected mass loss for the reduction of Mn₂O₃ to Mn₃O₄ is about 3.38%. The experimentally determined value was approximately 4%. Comparing these two values thus confirms the likelihood that the reduction of Mn₂O₃ into Mn₃O₄ is the first step of reducing the pure manganese oxide.

The second reduction step for the pure Mn₂O₃ appears as the first step for compositions in the range of 0<x≤2.4. This step has known contributions by the reduction of Mn³⁺ to Mn²⁺ in x=3, according to:

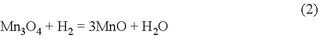

One factor to consider is that the intensity of this first reduction peak also increases with raising the cobalt content. Thus, the first reduction step may result from the reduction of both Mn³⁺ and Co³⁺ in the mixed oxides. Pure manganese oxide appears to be missing the peak that corresponds with the second reduction peak in the samples containing cobalt. This second reduction peak occurs in the temperature range of about 500° C.-750° C. This peak evolves and increases in intensity with the addition of Co; thus, this peak may be only attributed to the reduction of Co²⁺ to metallic cobalt. Thus, determining that the second reduction step is highly influenced by Co exsolution from the host material. The transformation of the spinels during reduction is observed to proceed as follows:

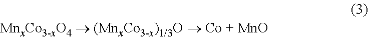

Increasing manganese content can stabilize the (MnₓCo₃₋ₓ)_{1/3}O over a relatively wider temperature range. This is evident by the loss of distinctiveness between the two reduction steps as cobalt content increases. From Table 2, it is also observed that a higher temperature is needed for the first reduction of the mixed oxides as manganese content decreases.

TABLE 2
Summary of temperature and weight change of MnₓCo₃₋ₓO₄,
x = 0-3 analyzed from thermogravimetric analysis data.

| | | | Reduction | Reduction | Reduction | Reduction | Oxidation | Oxidation | Oxidation | Oxidation |
|---|---|---|---|---|---|---|---|---|---|---|
| | | | Step 1 T | Step 1 | Step 2 T | Step 2 | Step 1 T | Step 1 | Step 2 T | Step 2 |
| Mn:Co | x | Phase | (° C.) | wt. % | (° C.) | wt. % | (° C.) | wt. % | (° C.) | wt. % |
| 1:0 | 3.0 | Tetragonal | 296 | 6.98 | — | — | 283 | 11.27 | — | — |
| 4:1 | 2.4 | Tetragonal | 268 | 8.33 | 578 | 2.83 | 264 | 11.20 | — | — |
| 3:2 | 1.8 | Tetragonal | 309 | 8.25 | 562 | 7.35 | 265 | 11.83 | — | — |
| 2:3 | 1.2 | Cubic | 347 | 7.80 | 555 | 10.07 | 302 | 13.97 | 603 | 10.47 |
| 1:4 | 0.6 | Cubic | 342 | 6.30 | 539 | 10.79 | 323 | 13.90 | 589 | 16.41 |
| 0:1 | 0.0 | Cubic | 329 | 4.21 | 437 | 18.53 | 336 | 36.90 | — | — |

Noticeably, there exists a higher rate of temperature change with composition in the tetragonal phase as compared to the cubic phase. Moreover, the reduced temperatures in the cubic phases have higher values as compared to those with tetragonal phases. The implication of these observations is that the first step—which involves the reduction of the spinels into the salt-like structure (MnₓCo₃₋ₓ)_{1/3}O—may also be influenced by the phase type of the Mn—Co spinel. Manganese substitution was previously discovered to influence the first reduction step. However, per the outcome in this study, it rather seems that the influence of manganese on the first reduction step is rather important in the spinels that have tetragonal phases. Hence, the first reduction may be influenced not solely by manganese content but also the spinel phase-type. The onset temperature for the second reduction step generally increased with manganese substitution. However, Mn²⁺ is not reduced in this stage as observed in the DTG analysis of the pure manganese oxide. Hence, this effect may be due to the relatively strong retention of oxygen atoms by manganese as compared to Co. This is also evident by the observed increase in oxygen loss when cobalt content increases. An increase in manganese content is also seen to drive the completion of the second reduction step to higher temperatures. For instance, the reaction ceases around 710° C. for x=1.2, as compared to ~770° C. for that of x=1.8.

The spinel oxide can be regenerated from the reoxidation process under air per the outcome of this study. EDX analysis on the reoxidized samples reveals a consistent Mn/Co ratio for all compositions with the original composition. TGA for the reoxidation of the reduced oxides was performed in air with a temperature ramp rate of 5° C./min. The reoxidation of the reduced powders follows a different reaction pathway as compared to that of the reduction reaction. Contrary to the two-step reduction process that was observed for all the mixed compositions, a rather single oxidation step is seen for the mixed oxides except for x=0.6 and 1.2. These two compositions show an extra shoulder peak, which is indicative of the formation of an intermediate product. Manganese substitution is also found to enhance spinel formation, this is evident by the reduction in reoxidation onset temperature for the mixed oxides as manganese content increased, this is observed in Table 2 and FIG. 5D. In situ reoxidation was further carried out in air at a ramp rate of 10° C./min. The aim was to understand the reoxidation mechanism for the reduced oxides and to identify intermediate and secondary phases that may be formed.

At room temperature, the reduced MnₓCo₃₋ₓO₄ primarily consists of metallic cobalt and MnO, with their characteristic XRD peaks shifting to lower angles as the temperature rises indicating an expansion of lattice. These phases remain stable up to approximately 300° C., at which point the first spinel-related reflection emerges as a broad peak around 20=36.5°. This peak corresponds to the 211 reflection of a tetragonal MnₓCo₃₋ₓO₄ spinel phase. Near this temperature, the material exhibits a mixture of the spinel phase, metallic cobalt, and MnO. The 211 reflection is particularly prominent in the XRD pattern of this spinel, which explains why it is the first to appear. As the temperature increases further to around 500° C., there is a sharp decline in the intensities of the MnO and metallic Co peaks, consistent with a steeper slope observed in the DTG reoxidation curve for x=2.4 at ~425° C. (not shown). This suggests an accelerated rate of spinel formation beyond this point. Additionally, new peaks corresponding to a cubic Mn₂O₃ phase emerge at 500° C., however, their intensities diminish with further heating. These observations suggest that the reoxidation pathway for x=2.4 likely proceeds through the following sequence:

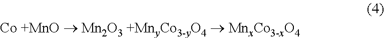

A different reoxidation pathway is observed for the composition with higher cobalt content (x=0.6). Similar to the x=2.4 case, the MnO and metallic Co peaks shift to lower angles with increasing temperature, indicating lattice expansion. However, no spinel-related peaks appear until approximately 400° C., suggesting that a higher cobalt content delays the onset of spinel phase formation. This trend aligns with the TGA data for the reoxidation reaction. A shoulder peak with a maximum near 547° C. is present for x=0.6, while such a feature is absent for x=2.4. In situ XRD analysis further reveals the formation of a substantial CoO phase during reoxidation for x=0.6, as evidenced by the appearance of characteristic 111, 200, and 220 reflections around 500° C. The emergence of this CoO phase likely accounts for the shoulder peak observed in the DTG data.

A further increase in temperature to 600° C. resulted in a decrease in the intensity of the CoO reflections. In contrast, there was a corresponding intensification and appearance of peaks belonging to a cubic MnₓCo₃₋ₓO₄ phase at this temperature. This explains the sudden change in the slope of the DTG curve for x=0.6 above 600° C. At around 800° C., a single-phased cubic MnₓCo₃₋ₓO₄ is achieved with no observed CoO secondary phases. Thus, in the reoxidation of MnO and rich metallic cobalt mixture, the kinetics for CoO formation are highly favorable and require higher temperatures >700° C. for single-phase spinel formation. This result justifies the tendency to form secondary CoO phases when synthesizing spinels with higher cobalt content and at relatively lower temperatures and in this study. Hence, the reoxidation pathway for x=0.6 is believed to proceed as follows: Co+MnO→CoO+Mn_{y}Co_{3-y}O₄→MnₓCo₃₋ₓO₄ (5)

Table 3 juxtaposes the difference in reoxidation behavior for the case of a manganese-rich, cobalt-rich, and intermediate composition.

TABLE 3
Summary of discrepancies in reoxidation for MnₓCo₃₋ₓO₄, x = 0.6,
Mn:Co 1:4 and MnₓCo₃₋ₓO₄, x = 2.4, Mn:Co 4:1 samples.

| | Composition | | |
|---|---|---|---|
| Property Summary | Mn:Co = 4:1 | Mn:Co = 1:4 | Mn:Co = 3:2 |
| Transitional temperature (T*) | 400° C. < T* ≤ 500° C. | 500° C. < T* ≤ 600° C. | 400° C. < T* ≤ 500° C. |
| Spinel onset temperature (T°ₛₚᵢₙₑₗ) | 300° C. | 400° C. | 300° C. |
| First peak | 211 | 311 | 211 |
| Secondary phases | Mn₂O₃ | CoO | None detected |

Note:
T* denotes temperature at which no reduced phase is observed.

The reduced forms of the spinels seem to have transitional temperatures where the peaks of the starting materials MnO and Co disappear or are diminished. This transitional temperature is represented in this work as T* and symbolizes a value that falls in the range summarized in Table 3. This range is also characterized by a corresponding increase in slopes of the DTG curves. A steeper DTG slope indicates that the rates of the spinel formation increase after the transitional temperature is reached. Manganese is seen to reduce the value of T* and thus favors the spinel formation. T⁰ₛₚᵢₙₑₗ denotes the temperature at which the first spinel peak was observed. This value is also seen to decrease with higher manganese content, further corroborating the promotion of spinel formation by manganese. Both Mn- and Co-rich compositions tend to form secondary phases at certain reoxidation temperatures. For x=2.4, secondary Mn₂O₃ peaks were obvious at 500° C. Conversely, the higher cobalt content composition: x=0.6 formed CoO secondary phases with peaks also identifiable at 500° C.

A commonality of both high and low cobalt compositions is that the secondary peaks diminish with increasing temperature. At 800° C., a single spinel phase can be achieved. Interestingly, intermediate composition x=1.8 shows no such secondary phase formation. Thus, spinel synthesis techniques such as reactive oxidative sintering may not be favorable for yielding single-phase Mn—Co spinel oxide, when MnO and Co are used as starting materials at temperatures lower than 800° C., and when Co or Mn contents is high (x=2.4 or 0.6 in this case). Hence, for relatively lower temperature applications, the intermediate Mn:Co composition such as x=1.8 may be optimum for yielding a single spinel phase.

The XRD patterns show that the resultant phases from the second reduction step are MnO and metallic cobalt. Hence, SEM images were taken to identify the surface morphology of these phases. For the SEM image of composition x=2.4, the morphology of the exsolved cobalt is mostly observed to be near-spherical. A further increase in cobalt content to yield x=1.8 resulted in an increase in the average particle size of the exsolved cobalt; however, some of these particles still exhibited a near-spherical morphology and the exsolved Co particles for both compositions preferentially grow along the grain boundaries.

A different surface morphology is observed when the composition transition from the tetragonal phase into the cubic phase. In the case of x=1.2, no such exsolved near-spherical Co particles were observed. According to the SEM images, the structure is rather compact with well interconnected grains. TEM and HAADF-EDS images also reveal that this interconnected network consists of MnO grains bonded to a neighboring Co metal.

The exsolved cobalt particles showed a tendency of growing along the grain boundaries in relatively low cobalt-containing compositions x=2.4 and 1.8. Therefore, it is speculated that for x=1.2, cobalt may have still grown along the grain boundary and nucleates in the same plane as the MnO matrix, forming a connection between the MnO grains. From there, the resultant interconnected structure is formed, and it is worth noting that this Co and MnO interconnected structure is seemingly unique to only x=1.2. It is not observed with a further increase in cobalt content in the case of x=0.6. At x=0.6, cobalt is rather seen to preferentially grow in a direction perpendicular to the plane in which the MnO matrix is formed. Notably, increasing cobalt content beyond x=1.2 also resolved in a transformation of the near-spherical exsolved cobalt shape to more of an irregular block-like shaped morphology as observed in x=0.6.

The observations indicate that except for mid-range composition x=1.2, cobalt tends to generally grow perpendicular to the plane in which MnO is formed. Moreover, the shape and size of the exsolved cobalt are strongly influenced by the composition. Thus, lower cobalt content resolves in a more rounded or near-spherical shape with relatively smaller exsolved particles. A higher cobalt content on the other hand promotes block-like structures with relatively larger Co particles. Nanocrystalline MnO composite with trace metallic Co and carbon (Co/MnO—C), for instance, was previously reported as an outstanding bifunctional oxygen electrocatalyst. Specifically, the presence of Co was thought to enhance the catalyst's oxygen adsorption capability. This capability is believed to have resulted from the creation of oxygen vacancies, which is promoted by the charge transfer structure between metallic cobalt and MnO. Hence, the current disclosure shows that for such catalytic applications, the composition can be tuned to yield optimum and desired Co particle sizes and morphology.

As disclosed herein, TGA and in situ XRD were employed to illustrate the reduction and reoxidation behavior of a series of manganese and cobalt spinel oxides. Mn/Co-based spinels were observed to crystallize in a tetragonal phase for high manganese-containing compositions and in the cubic phase for cobalt-rich samples. TGA analysis reveals a two-step reduction for the mixed spinels. The first step is previously reported to have resulted in the formation of a (MnₓCo₃₋ₓ)_{1/3}O intermediate, and the second step yields metallic fcc metallic cobalt and MnO. Manganese tends to impede the reduction of the spinel as observed from the shifting of reduction temperatures to higher values. Moreover, an influence of the spinel phase-type on the reduction temperatures of the first step is also seen. For example, the cubic phase tends to impede the reduction of the spinels into the intermediate structure as compared to the tetragonal phase. The first reduction step, which is known to transform the spinels to intermediate (MnₓCo₃₋ₓ)_{1/3}O, may thereby be influenced by both manganese content and the phase-type.

Reoxidation of the spinels follows a different pathway unlike the reduction process. The reduction process shows a two-step reaction for the temperature range employed, whereas a single reoxidation step is observed for most compositions except for compositions x=0.6 and 1.2. The study revealed that manganese tends to lower the reoxidation temperatures and hence promotes spinel formation. Extreme-end spinels, manganese- and cobalt-rich, x=2.4 and 0.6 in this case, gave rise to secondary Mn₂O₃ and CoO, respectively, during reoxidation. Therefore, such compositions may not be optimum for yielding a single-phase spinel at temperatures lower than 800° C. when techniques such as reactive oxidative sintering are employed for spinel synthesis. Mid-range composition x=1.8, however, showed no secondary phases during reoxidation and may be suitable for such applications. An investigation of the morphology of the reduced samples showed that MnO formed upon reduction preferentially forms a backbone on which metallic Co grows. An exception to this observation is the mid-range composition x=1.2, which uniquely forms an interconnected network with the MnO. Moreover, Co tends to grow along the grain boundaries, especially in low cobalt compositions such as x=2.4 and 1.8. The current disclosure also reveals that Co may segregate in a near-spherical morphology for lower cobalt content compositions and a rather block-like structure for higher cobalt compositions. A compositional effect on Co particle size is also realized, increasing cobalt content consequentially increases the size of the exsolved Co particles.

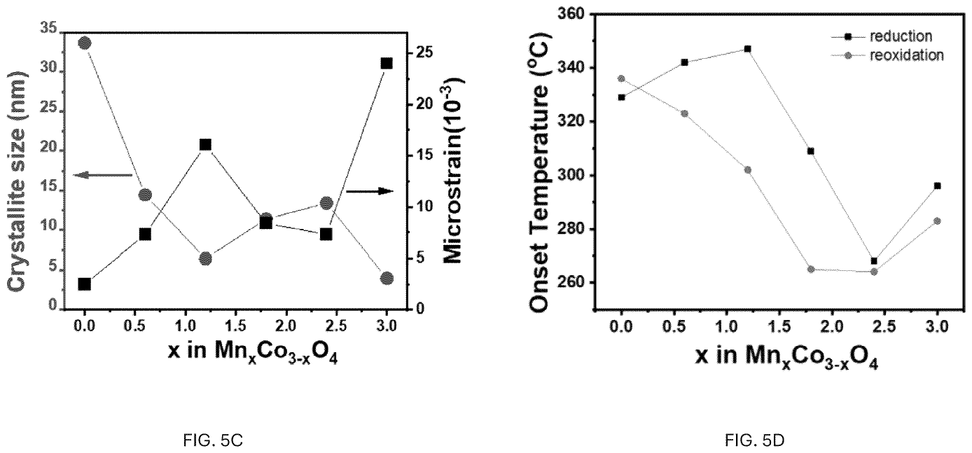

FIGS. 6A-6C illustrate scanning electron microscope images of a calcined intermediate that comprises a manganese-cobalt spinel oxide having a nominal composition of Mn_{1.5}Co_{1.5}O₄, under the different magnification with scale bars of 5 μm, 2 μm, and 500 nm, respectively. The calcined intermediate exhibits a particle size ranging from about 30 nm to about 100 nm. The particles are loosely aggregated and weakly bonded to one another, resulting in a relatively porous microstructure with limited mechanical strength.

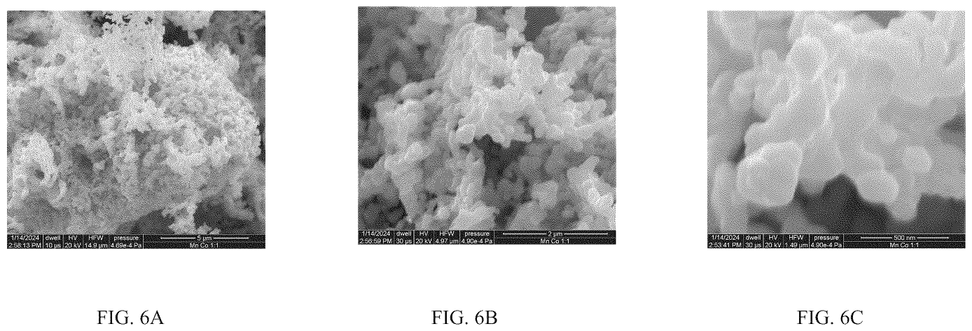

FIGS. 7A-7C illustrate scanning electron microscope images of a bonding layer that comprises a single-phase spinel-type metal oxide under the different magnification with scale bars of 5 μm, 2 μm, and 500 nm, respectively. The bonding layer exhibits a grain size ranging from about 200 nm to about 800 nm. The particles are chemically bonded to one another, thereby forming a dense microstructure with high mechanical strength.

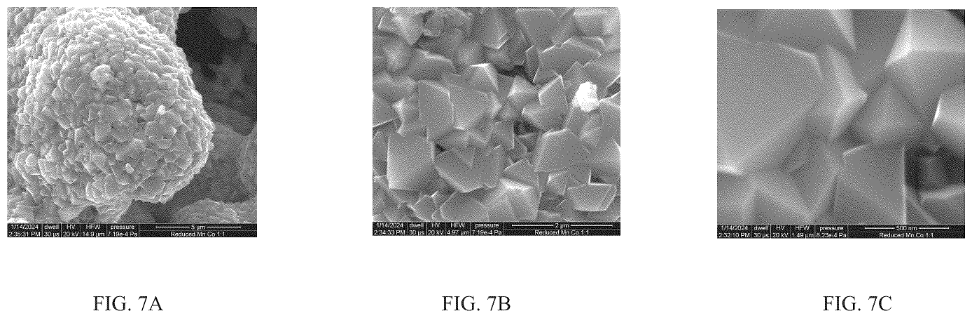

FIG. 8 is a graph depicting x-ray diffraction (XRD) patterns of the spinel prior to reduction. The XRD results confirm the formation of a single-phase manganese-cobalt spinel oxide having a nominal composition of MnₓCo₃₋ₓO₄ after calcination at about 400° C.

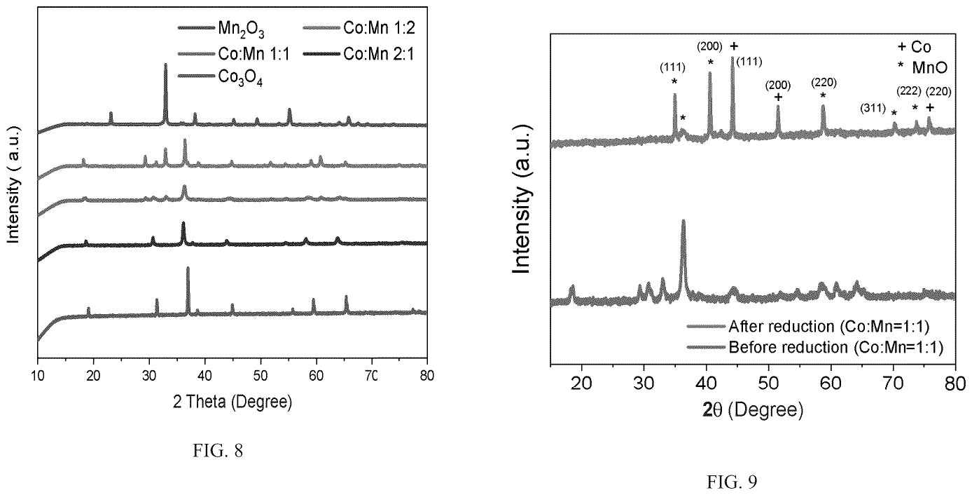

FIG. 9 is a graph depicting XRD patterns of the material after reduction. The XRD results indicate a phase transformation of the single-phase MnₓCo₃₋ₓO₄ spinel oxide shown in FIG. 8 into a multiphase composite. After reduction in an atmosphere comprising 5% H₂ and 95% Ar at about 700° C., diffraction peaks corresponding to metallic cobalt and lower-valence manganese oxides are observed, demonstrating decomposition of the spinel structure during the reduction process.

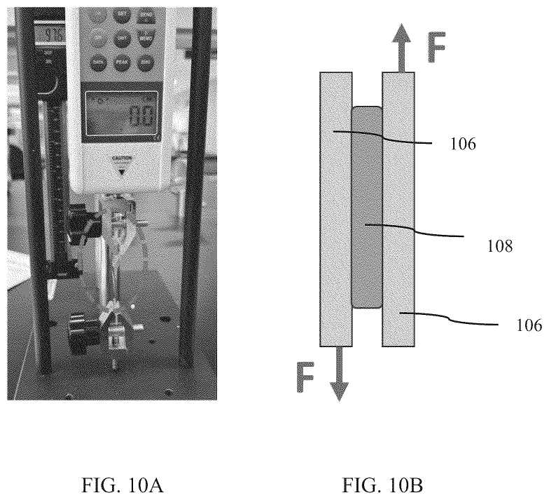

FIG. 10A illustrates an example of a test apparatus used to perform a shear stress test on a bonding layer disposed on a substrate. The bonding layer comprises a single-phase spinel-type metal oxide as described herein. FIG. 10B illustrates a schematic representation of the test configuration, in which the arrow labeled “F” indicates the direction of the applied shear force. To evaluate the bonding strength between a 430 stainless steel substrate 106 and the bonding layer 108 formed from the contact paste, a shear stress test was conducted using the configuration shown in FIGS. 10A and 10B. In the test, approximately 0.1 grams of the contact paste was applied to a 2 cm by 2 cm 430 stainless steel coupon to form a paste layer. A second 430 stainless steel coupon having the same dimensions was then placed on top of the paste layer in alignment with the bottom coupon, thereby forming a sandwich structure. A dead weight of approximately 350 grams was placed on the top coupon, and the assembly was sintered at a temperature of about 800° C. to form the bonding layer between the coupons. After sintering and cooling, two adhesive tapes were affixed to opposing sides of the bonded stainless steel coupons, and a shear force was applied to separate the bonded coupons. The maximum shear force to break the sandwich structure was recorded. The shear stress test was repeated for bonding layers formed from different materials, and the corresponding maximum forces were measured for comparison.

Table 4 illustrates shear test results obtained for bonding layers formed from different contact paste materials. As shown in Table 4, bonding layers formed from a reduced manganese-cobalt oxide (CMO) material prepared as disclosed herein and reduced at about 750° C. exhibited substantially higher shear forces compared to bonding layers formed from unreduced manganese-cobalt oxide spinel and a commercial lanthanum strontium cobaltite (LSC) material. Specifically, the reduced CMO samples demonstrated maximum shear forces of approximately 22.4 N, 25.0 N, and 31.6 N across three test samples, indicating strong interfacial bonding between the 430 stainless steel coupons. In contrast, bonding layers formed from manganese-cobalt oxide spinel prepared by a glycine-nitrate combustion process and annealed at about 700° C. exhibited lower shear forces of approximately 2.6 N and 2.8 N. Bonding layers formed from the commercial LSC material showed comparatively low and variable shear forces of approximately 0.6 N, 6.2 N, and 3.6 N. These results indicate that partial reduction of the manganese-cobalt oxide prior to sintering can substantially enhance bonding strength, as measured by shear resistance, relative to unreduced spinel materials and commercially available contact layer compositions.

TABLE 4

| | | Sample | Sample | Sample |
|---|---|---|---|---|
| | | 1 test | 2 test | 3 test |
| Materials | Description | (N) | (N) | (N) |
| Reduced CMO | House made CMO reduced at | 22.4 | 25.0 | 31.6 |
| | 750° C. | | | |
| (Co,Mn)₃ O₄ (CMO) | From glycine nitrate combustion | 2.6 | 2.8 | — |
| | process, annealed at 700° C. | | | |
| LSC | Commercial. (from Fuel cell | 0.6 | 6.2 | 3.6 |
| | materials) | | | |

The disclosed solid oxide energy storage devices comprising the cathode bonding layer and/or the anode bonding layer can be used in various vehicles that have at least one electric motor that is operative to provide motive torque. The vehicles comprise passenger vehicles such as sedans, sport utility vehicles (SUVs), and light-duty trucks; commercial and heavy-duty vehicles such as delivery vans, Class 8 trucks, and refrigerated transport vehicles; public transit vehicles comprising shuttle buses, school buses, and city transit buses; rail-based vehicles such as locomotives and passenger trains; marine vessels comprising ferries, tugboats, and cargo ships; aerospace platforms such as unmanned aerial vehicles (UAVs), electric vertical takeoff and landing (eVTOL) aircraft, and hydrogen-powered airplanes; as well as specialty vehicles comprising motorcycles, scooters, forklifts, and other off-road or industrial transport systems.

When introducing elements of the present invention or the embodiment(s) thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements. The term “exemplary” is not intended to be construed as a superlative example but merely one of many possible examples.

In the drawings, not all reference numbers are included in each drawing, for the sake of clarity. In addition, positional terms such as “upper,” “lower,” “side,” “top,” “bottom,” etc. refer to the apparatus when in the orientation shown in the drawing. A person of skill in the art will recognize that the apparatus can assume different orientations when in use.

Various other components may be included and called upon for providing for aspects of the teachings herein. For example, additional materials, combinations of materials and/or omission of materials may be used to provide for added embodiments that are within the scope of the teachings herein. Adequacy of any particular element for practice of the teachings herein is to be judged from the perspective of a designer, manufacturer, seller, user, system operator or other similarly interested party, and such limitations are to be perceived according to the standards of the interested party.

What is claimed is:

1. A bonding layer disposed on a substrate, the bonding layer comprising:
a single-phase spinel-type metal oxide having a nominal composition of MnₓCo₃₋ₓO₄, where x ranges from 0 to 3, excluding x=2,
wherein the bonding layer is formed by sintering a reduced calcined intermediate such that the reduced calcined intermediate is reoxidized during the sintering to form the single-phase spinel-type metal oxide, and
wherein the reduced calcined intermediate is from a calcined intermediate produced by calcining an oxide intermediate precursor formed by a combustion reaction between an organic fuel and a precursor comprising one or more metal nitrates that comprise manganese nitrate, cobalt nitrate, iron nitrate, copper nitrate, nickel nitrate, zinc nitrate, and a combination thereof.

2. The bonding layer of claim 1, wherein the one or more metal nitrates comprise manganese nitrate Mn(NO₃)₂·xH₂O and cobalt nitrate Co(NO₃)₂·xH₂O, where x is greater than zero.

3. The bonding layer of claim 1, wherein the single-phase spinel-type metal oxide has a cubic, a distorted cubic, or a tetragonal crystal structure.

4. The bonding layer of claim 1, wherein the single-phase spinel-type metal oxide is substantially free of secondary oxide phases comprising CoO and Mn₂O₃, as determined by X-ray diffraction.

5. The bonding layer of claim 1, wherein x is about 0.5 to about 2.5.

6. The bonding layer of claim 1, wherein the bonding layer has a thickness of about 5 micrometers to about 100 micrometers.

7. The bonding layer of claim 1, wherein the bonding layer provides mechanical bonding and electrical contact between the substrate and an adjacent component, wherein the substrate and the adjacent component comprise an anode, a cathode, or an interconnect of a solid oxide fuel cell.

8. The bonding layer of claim 1, wherein the bonding layer exhibits an area-specific resistance of less than 0.1 Ω·cm² at an operating temperature of a solid oxide fuel cell.

9. A method of forming a bonding layer on a substrate, the method comprising forming a first mixture comprising a precursor, an organic fuel, and a first solvent, wherein the precursor comprises one or more metal nitrates comprising manganese nitrate, cobalt nitrate, iron nitrate, copper nitrate, nickel nitrate, zinc nitrate, and a combination thereof;
stirring the first mixture to form a homogeneous first mixture;
heating the homogeneous first mixture at a first temperature to evaporate the first solvent and form a gel-like first mixture;
heating the gel-like first mixture at a second temperature to initiate a combustion reaction between the organic fuel and the one or more metal nitrates and thereby form an oxide intermediate precursor;
calcining the oxide intermediate precursor at a third temperature in an oxidizing atmosphere to form a calcined intermediate comprising a manganese-cobalt spinel oxide having a nominal composition of MnₓCo₃₋ₓO₄, where x ranges from 0 to 3, excluding x=2;
exposing the calcined intermediate to a reducing gas mixture at a fourth temperature to at least partially reduce the calcined intermediate and form a reduced calcined intermediate;
forming a contact paste comprising the reduced calcined intermediate and an organic constituent and
applying the contact paste to a surface of the substrate and sintering the contact paste at a fifth temperature to remove the organic constituent and form the bonding layer on the substrate, wherein the bonding layer comprises a single-phase spinel-type metal oxide formed by reoxidation of the reduced calcined intermediate during the sintering.

10. The method of claim 9, wherein forming the contact paste comprises grinding and sieving the reduced calcined intermediate to form a powder having a maximum particle size of 5 micrometers, wherein the grinding comprises ball milling, attrition milling, bead milling, planetary milling, vibratory milling, rod milling, jet milling, a combination thereof.

11. The method of claim 9, wherein the one or more metal nitrates comprise manganese nitrate Mn(NO₃)₂·xH₂O and cobalt nitrate Co(NO₃)₂·xH₂O, where x is greater than zero.

12. The method of claim 9, wherein the first temperature is about 130° C. to about 180° C., the second temperature is about 300° C. to about 400° C., the third temperature is about 400° C. to about 600° C., the fourth temperature is about 700° C. to about 800° C., and the fifth temperature is less than 900° C.

13. The method of claim 9, wherein the fifth temperature is between 75° and 850° C.

14. The method of claim 9, wherein the organic fuel comprises glycine and wherein the first solvent comprises distilled water, deionized water, or purified water.

15. The method of claim 9, wherein the organic constituent comprise a binder and a second solvent, wherein the binder comprises ethyl cellulose, polyvinyl butyral, acrylic binders, or a combination thereof, and the second solvent comprises terpineol, alcohols, glycols, or a combination thereof.

16. The method of claim 9, wherein a molar ratio of the organic fuel to nitrate ions of the one or more metal nitrates is about 1:1.

17. The method of claim 9, wherein the reducing gas mixture comprises hydrogen and an inert gas, wherein the inert gas comprises argon or nitrogen.

18. The method of claim 9, wherein the precursor has a maximum particle size of 20 micrometers (μm), and wherein the precursor has an average particle diameter of about 0.1 μm to about 20 μm.

19. A solid oxide fuel cell, comprising:
an anode, a cathode, an electrolyte disposed between the anode and the cathode, and an interconnect electrically coupled to at least one of the anode or the cathode; and
a bonding layer disposed on at least one of the anode, the cathode, or the interconnect, wherein the bonding layer comprises a single-phase spinel-type metal oxide having a nominal composition MnₓCo₃₋ₓO₄, where x ranges from 0 to 3, excluding x=2,
wherein the bonding layer is formed by sintering a reduced calcined intermediate such that the reduced calcined intermediate is reoxidized during the sintering to form the single-phase spinel-type metal oxide, and
wherein the reduced calcined intermediate is derived from a calcined intermediate produced by calcining an oxide intermediate precursor formed by a combustion reaction between an organic fuel and a precursor comprising one or more metal nitrates comprising manganese nitrate, cobalt nitrate, iron nitrate, copper nitrate, nickel nitrate, zinc nitrate, or a combination thereof.
